(19) United States
(12) Patent Application Publication
(10) Pub. No.: US 2002/0156813 A1
(43) Pub. Date: Oct. 24, 2002

(54) Developing documents

(76) Inventor: Thomas Godfrey Gardner, Bristol (GB)

Correspondence Address: HEWLETT-PACKARD COMPANY, Intellectual Property Administration, P.O. Box 272400, Fort Collins, CO, 80527-2400, US

(21) Appl. No.: 10/112,506

(22) Filed: Mar. 28, 2002

(30) Foreign Application Priority Data
Mar. 28, 2001 (GB) 0107784.1

(51) Int. Cl. G06F 17/00

(52) U.S. Cl. 707/513

(57) ABSTRACT

A method of developing a source document and associated system are disclosed. The source document (30) is written in a content markup language or page description language and is intended to be displayed on a plurality of target devices, the method comprising concurrently transforming and/or rendering the source document (30) into two or more outputs (24,26,28) each showing how the source document (30) would be displayed on a predetermined target device and displaying the outputs (24,26,28) for a user to view.

### BACKGROUND OF THE INVENTION

1. Field of the Invention

This invention relates to an improved system and method of developing a source document, particularly, but not exclusively for assisting in the development of a document for publication on a variety of media.

2. Description of the Related Technology

Many documents are now produced using computers. Such documents may be intended for printed publications, such as newspapers, magazines, books, etc. or for electronic publication, such as for e-mails, pages to be displayed on the World Wide Web, etc.

Page description languages are well known to achieve such computer-based publications. These description languages provide instructions for a page renderer so that the final page can be produced from the given instructions. Therefore, the instructions provided to the renderer contain not only the content of the document, but also information about how the content should be arranged on any two dimensional medium including paper and computer screens and smaller displays such as those found on handheld devices. Well known page description languages include LaTeX, POSTSCRIPT, HTML.

Cross-media publishing acknowledges the existence of a rich diversity of page description languages targeted for a wide range of media from the printed page to mobile telephones. There is a need to distinguish the content of a document from the aspect of its presentation. This content is contained in a so-called content document and is expressed in a “content markup language”. Such content markup languages do not include layout information and are thus effectively device independent. It would be standard practise to apply a functional transformation to the content document to create a new document expressed in an appropriate page description language.

A problem with the use of such content markup languages and page description languages is that a user cannot see what the finished document will look like until the documents have been rendered, as shown in FIG. 1. Furthermore, the rendered document can look different on different display medium (for example a document rendered as an HTML document can look different when displayed on different browsers). Therefore, when tweaking, and making final adjustments to a document, a user may have to continuously make adjustments to the content document, and render the page to see if the adjustment is satisfactory, possibly for each different display medium on which the document is to be presented. This can be a time consuming practise.

The previously discussed problems can be increased when content markup languages such as those defined by the XML (extensible markup language) specification are used to specify the content to be displayed. As discussed, unlike the traditional page description languages described hereinbefore, an XML language does not contain information relating to the layout of the published document, but simply defines the information held within the content document. The person skilled in the art will readily understand this.

In certain situations an XML content document must be transformed by an intermediate level processor before being passed to the renderer, as shown in FIG. 2. One such example is a transform processor, which combines the XML source content document with a CSS style sheet that specifies how the transform processor should convert an XML content document into HTML for rendering. The use of such an intermediate processor increases the complexity if a user wishes to see how a document would look when displayed on a display.

Some commercially available software packages allow multiple views of a single document. For example there is the word processing package produced by the Microsoft Corporation under the Trade Mark WORD™ that allows a user to display print and web page previews of a document on which they are working.

Further, Quark Inc., produce a desktop publishing software package under the Trade Mark QUARKXPress™. A module to extend the capabilities of this package is available under the Trade Mark avenue.quark™. Avenue.quark™ allows a user to extract the content from a QUARKXPress™ document and export it as an XML file, which can be used to create web pages, etc. Avenue.quark™ provides windows in which the content and the XML can be viewed simultaneously. Avenue.quark™ also allows XML to be imported in to QUARKXPress™ documents.

This invention tries to ameliorate at least some of the problems of the prior art.

### SUMMARY OF THE INVENTION

According to a first aspect of the invention there is provided a system arranged to allow concurrent display of two or more outputs generated from a source document, written in a content markup language or a page description language, that it is desired to display on a plurality of target devices, each output being generated by an associated transform and/or render module from the source document, and showing how the source document would be displayed on a particular target device, the system comprising a display arranged to display the two or more outputs, at least one input allowing the source document to be edited, and processing circuitry arranged to transform and/or render the source document into each of the two or more outputs.

The method may concurrently transform and render the original source document to produce the one or more outputs.

Such a system is advantageous because it will allow a particular source document to be developed much quicker than in prior art systems in which a source document was developed for a single source device at a time.

It will be appreciated that as the Internet develops that the access devices used are becoming increasingly diverse. Current devices that users use to make access include any of the following: WAP phones, web enabled computers such as PC's, Apple™ computers, etc., television sets, etc. As the Internet develops further, further diversification is likely to occur. The processing circuitry may be arranged to simulate the displays of target devices.

For example the processing circuitry may be arranged to cause the display to display simulations of any one or more of the following: WAP telephones; television sets; Internet browsers; any other Internet enabled device. The processing circuitry may be arranged to allow a user to select from a list the devices for which they wish a simulation to be displayed.

The processing circuitry may be Internet enabled, i.e. be capable of accessing the Internet. The processing circuitry may be arranged to cause the display to display the output that would be generated by the processing circuitry when accessing the Internet. An advantage of this is that this would not require a simulation, but would produce an actual display.

Preferably, the processing circuitry is arranged to generate the outputs of the transforms in real time, or substantially real time. Such an arrangement is advantageous because it provides a system that readily allows a user to see how the source document will appear.

The system may also be arranged such that a user periodically causes the system to generate the outputs. For example an input means may be provided to provide the user with an option to cause the outputs to be generated. The input means may comprise a key press, or combination of key presses, a portion of touch screen, an icon activated by a pointer, a menu option, etc. In such a system the processing circuitry would be arranged to generate the transform outputs periodically.

The system may comprise a data feed arranged to provide data that can be used to generate the source document. Such a data feed is advantageous because it allows the source document to contain up to date data from means such as news feeds, etc.

In some embodiments the system may be able to generate an output from only one of a page description language, or content markup language. The system may for example only be able to generate an output from a source document written in a content markup language. Alternatively, the system may be only able to generate an output from a source document written in a page description language.

According to a second aspect of the invention there is provided a method of developing a source document, written in a content markup language or a page description language, for display on a plurality of target devices, the method comprising concurrently transforming and/or rendering the source document into two or more outputs each showing how the source document would be displayed on a predetermined target device and displaying the outputs for a user to view.

Such a method is advantageous because it allows a user to more easily develop a source document that it is desired to view on a number of different target devices.

The method may allow a user to select from a list, or otherwise specify, the target devices for which they wish an output to be displayed. Such an arrangement provides a customisable method that is convenient for a user.

Preferably, when a user specifies that they wish an output to be display for a particular target device, the renderer and/or transform for that particular device is obtained. As such the renderer may be thought of as a plug in module (a render module), and the transform may be provided as a transform module. Such a method is convenient because it means that the renderer and/or transform is not required until the target device is specified thereby simplifying the requirements.

The render and/or transform modules may be obtained from a variety of sources. Any one or more of the following may be available: the modules may be available on a mass storage device, such as the hard drive of a computer and may be loaded into the memory of the computer for use; the modules may be available on a mass storage device of a computer and be made available for access by a computer when needed; the modules may be loaded onto a hard drive and/or memory from a computer readable medium. (Computer readable medium may have any of the meanings defined hereinbelow).

It is convenient for the render and/or transform modules to be made available for parties to obtain, perhaps by downloading from the Internet. As such, the manufacturers of the devices for which the modules generate an output, or any other third party, may produce the module. This is convenient because it may be difficult for users to write their own modules and providing them would remove the need.

The transform module may filter the contents of the source document. For example some information may be passed to the output document by some transforms, but blocked by others. Such a situation would allow different devices to display different information. For example the source document may comprise an address book containing both personal and work details. The transform documents may let the minimal details required to make contact through to some devices (may be WAP phones) and let the complete business details through to other devices (may be Internet browsers).

The source document may conveniently be written in XML (extensible Markup Language). The use of DTD's (Document Type Definitions) and schemas in conjunction with an XML document allows documents that can easily be searched and referenced to be produced. The skilled person will appreciate that an XML specification language is possibly a language that may be used to replace HTML as the language in which web pages are written. Other appropriate languages are defined by SGML and XHTML specifications.

In one embodiment XSLT (eXtensible Stylesheet Language Transformations) specifies the transform to be performed by the transform modules, but could be implemented in any number of ways. XSLT is particularly convenient if XML is used to write the source document.

Specific software modules, or drivers, may be needed in order to display the output of a transform on the display (i.e. render the output). In one embodiment the render modules may be obtained, or plugged in, as required. Obtained may have any of the meanings outlined above.

The output of each transformation and/or rendering may be displayed in its own window. As such, each window may be activated as desired by a user. Such an arrangement is especially advantageous if a user is performing more renderings than can be comfortably fitted onto a screen, in which case the user can activate the windows in which they are interested at any one time and deactivate others. De-activation may be by way of minimisation, closing, etc.

Renderings associated with windows that have been de-activated may continue to run, or alternatively, may only be run when the window is reactivated.

The output of each transform and rendering may be activated as and when desired. This is advantageous for the same reasons as discussed in relation to the provision of windowed outputs for each transformation.

A text entry window may be provided in which a user may edit the source document. Such a text entry window is convenient because a user will be provided with a complete editing environment in which he/she can make edits and see the results.

The source document may be created from scratch. Alternatively, or additionally, the source document may be loaded into a system running the method. Loading of the source document may be via a storage device of the computer on which the software is running. For instance from the hard drive, floppy drive, ZIP™ drive, etc. or may be by way of a data feed. The data feed may for example be a news feed, etc.

In some embodiments the method may be able to generate an output from only one of a page description language, or content markup language. The method may for example only be able to generate an output from a source document written in a content markup language. Alternatively, the system may be only able to generate an output from a source document written in a page description language.

According to a third aspect of the invention there is provided a computer readable medium having stored therein instructions for causing a processing unit to execute the method of the second aspect of the invention.

The computer readable medium may be any one or more of the following: a floppy disk, a ZIP™ disk, an LS120 disk, a CDROM, a DVD ROM/RAM, any other form of magneto-optical disk, a transmitted signal, an email message, or any other suitable medium.

According to a fourth aspect of the invention there is provided a machine having a display that can be arranged to concurrently display a number of outputs generated by the method of the second aspect of the invention.

There may be further ways of looking at the invention. For instance the invention may comprise providing a method of organising data on a primary processing apparatus; it may comprise increasing the speed of developing a document; it may increase comprise provide a method of ensuring that a data is correctly received by a number of data-receiving devices. A system may also be provided for performing the methods mentioned in this paragraph.

### BRIEF DESCRIPTION OF THE DRAWINGS

There now follows by way of example only a detailed description of the present invention with reference to the accompanying drawings and appendix of which:

FIGS. 1 and 2 show block diagrams for the prior art;

FIG. 3 shows a schematic layout for a typical computer system that may be used to provide the present invention;

FIG. 4 shows a schematic layout for one embodiment of the software for realising the present invention;

FIG. 5 shows a flow chart showing one possible use of the application from initialisation;

FIG. 6 shows how a screen dump for software providing this invention may look;

FIG. 7 shows an example of rendered WML; and

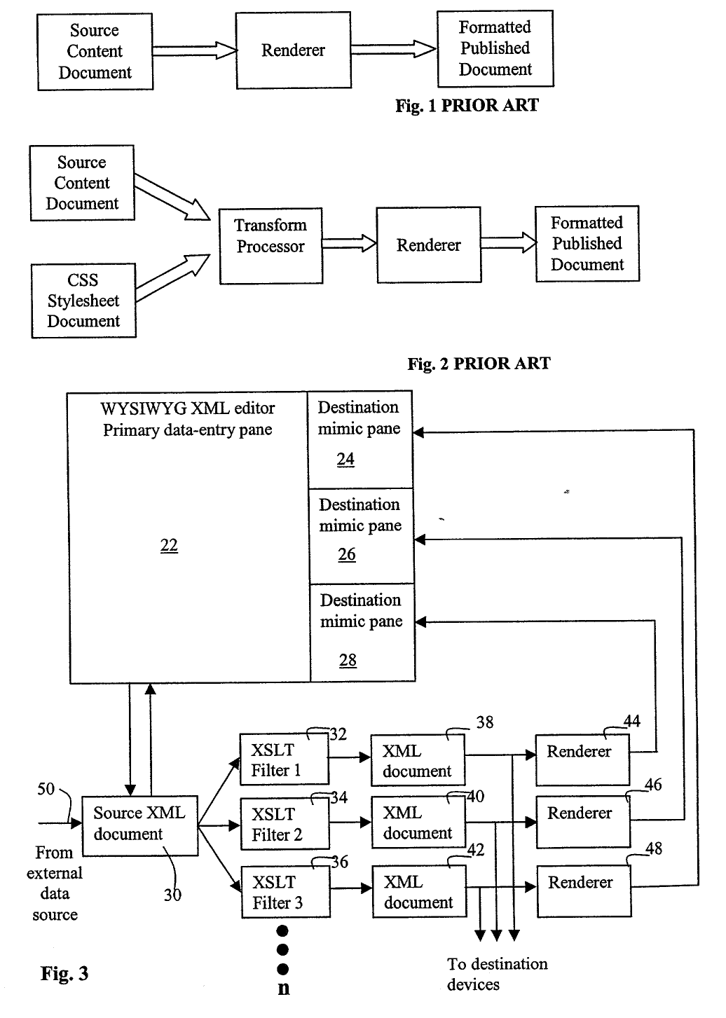

Appendix 1 shows example documents and transforms

The typical computer system 1 shown in FIG. 3 comprises a display 2, in this case a conventional cathode ray monitor, a keyboard 4, mouse 6 and processing circuitry 8. The processing circuitry comprises a number of sub components: a processor 10, system memory 12, display controller circuitry 14, a mass storage device 16 (in this case a hard drive), and an /IO controller 18. The sub components of the processing circuitry communicate with one another via a system bus 20.

In this embodiment the keyboard and mouse 6 use a universal serial bus (USB) to communicate with the I/O controller 18 of the computer system. Of course other mice 6 and keyboards 4 are well known.

Such a processing circuitry may be provided by a number of different computer systems that are currently available. There is the architecture referred to a PC, which historically is based around the X86 range of processors produced by the INTEL™ Corporation. Other computer system such as those produced by APPLE™, or any other suitable system may be used.

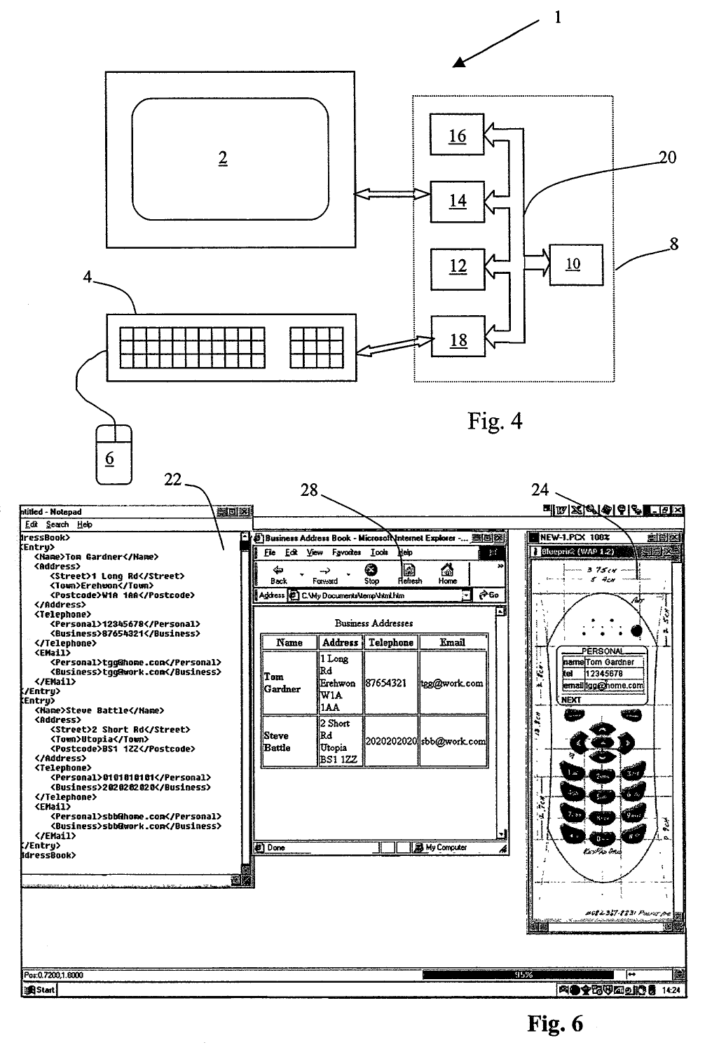

Central to the layout shown in FIG. 4 is the text entry window 22, which allows a user to enter and edit a source document on which they are working. The text entry window may run any of the well known text editor TM such as WINDOWS NOTEPAD™, or an editor specialised for XML content such as Windows XML Notepad™.

Shown to the right of the text entry window are three destination mimic pane windows 24, 26, 28, which are arranged to display a simulation of the how text entered in the text entry window 22 would appear when displayed on a target device. (Each of the destination mimic pane windows 24, 26, 28 is associated with a specified predetermined target device). Although the destination window mimic pane windows 24, 26, 28 are shown in a single column they are provided as separate windows that may be arranged on the display 2 of the computer as the user desires as is well known within any Graphical User Interface (GUI).

In this example the source document is entered, by the user, as an XML document, represented in FIG. 4 by the block 30. An XSLT transform module 32, 34, 36 is provided for each of the destination mimic pane windows 24, 26, 28. In this example as there are three destination mimic pane windows 24, 26, 38 three transforms are required.

As an example the, destination mimic pane window 24 may display a simulation of how the source document 30 would appear on a WAP phone, the window 26 may display how the source document 30 would appear on an Internet enabled television set and the window 28 may display how the source document 30 may appear on an Internet browser, such as Microsoft Explorer™.

Each of the transform modules generates an output document 38, 40, 42, in this case an XML document, suitable for displaying on the associated target device (the WAP phone, television, or browser). The output document is passed to a render module 44, 46, 48 that generates a simulation of how the output document 38, 40, 42 would look and passes this simulation to the processing circuitry 8 for display in the associated destination mimic pane window 24, 26, 28.

Therefore, in this embodiment as the user edits the source document 30 in the text entry window 22 he can see how this would be displayed on target devices simulated in the destination mimic pane windows 24, 26, 28. These windows are updated in real time so that as a user makes an alteration these changes are displayed. In other embodiments the destination mimic pane windows 24, 26, 28 are only updated when the user specifies that they should be updated, perhaps by pressing a key combination, activating an icon, etc.

As will be noted from FIG. 4 the output documents 38, 40, 42 are suitable for sending directly to the destination device. Therefore, using the examples given above output document 42 is a WML document suitable for sending to a WAP phone, output document 40 is suitable for sending to a web enabled television and output document 38 is an HTML document suitable for sending to an Internet browser. Separate output documents are only created once a user is happy that the outputs as displayed in the destination mimic pane windows 24, 26, 28 are as desired. These separate outputs are created by a user activating an option to create them (e.g. a keyboard combination, an icon, menu option, etc.).

FIG. 6 shows a screen shot of one possible embodiment of the present invention. The text entry window 22 is shown to the left most side of the Figure and has an XML document therein. Only two destination mimic pane windows are shown: that for a WAP enabled telephone 24 and that for a browser 28. These windows can utilise all of the functions of the operating system upon which the software is running. For instance each window can be resized, minimised, closed, maximised, etc.

It is possible for the source document 30 to be received from an external data source 50 such as an external news feed or the like. A user could then edit the source document 30 using the text entry window 22. It is of course also possible to load the source document 30 onto the computer system using any of the computer systems storage devices (for example CDROM, DVD ROM, floppy disk, etc.).

The system shown is customisable in that further transform modules 32, 34, 36 and render modules 44, 46, 48 can be added to the system (or removed from the system) if it is desired to develop the source document 30 for further target devices (i.e. other that the WAP phone, the web enabled television, or the web browser). For example a user may wish to develop the source document 30 for a different kind of web browser than simulated by destination mimic pane window 28 (For example Netscape Navigator™).

A range of transform modules 32, 34, 36 and render modules 44, 46, 48 are supplied with the system. Should a user desire modules that have not been supplied, or modules are updated new modules are made available for down load via the Internet (via FTP, or web download, etc.).

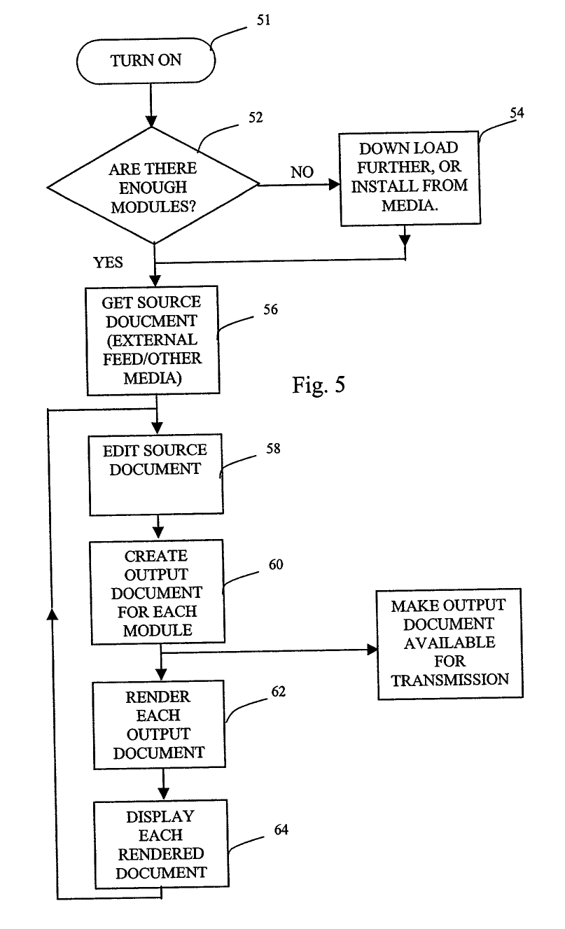

The flow chart of FIG. 5 shows one possible process flow for the system according to the present invention. After turning the system on 51, the user decides whether the correct target devices are being simulated 52. If they are not then the user proceeds to set us the simulations for the devices they require 54.

This setting up of the devices may be by way of activating simulations from the computers hard drive, downloading further modules, de-activating simulations that they no longer require. Once the user is happy that the correct simulations have been set up they proceed to obtain a source document 56. This source document may be obtained from an external feed such as a news feed, may be loaded from a computer readable medium, or may be created from scratch.

Once the source document is obtained the user can edit it in the text entry window, background processes create output documents 60 from the source document, which are rendered 62 and displayed 64 on the display of a computer screen. This process of editing 58, creating output document 60, rendering 62, and displaying 64 continues until halted by the user.

Once the user is happy that the various output documents will be displayed correctly, the output documents created by the process 60 are suitable for sending to the actual target devices. The user activates the creation of files suitable for sending to the target devices by activating an option within the software.

Appendix I shows an example source document, example XSL transforms, example HTML, and WML documents produced by the transforms, and examples of the rendered HTML and WML documents.

XML requires pairs of tags to be placed within a document. Theses tags do not specify how the information should be presented, but specify the content of the information between the pairs of tags. The skilled person will fully understand XML, but a full description can be found at www.w3.org, and the brief description below will aid his/her understanding.

Example data written in XML, is shown in Appendix I. The skilled person will appreciate how an XML document is structured: written in words, or data sub-items, which are collected into data sub-item groups. The data sub-item groups can comprise sentences, paragraphs, or simply collections of words. The data sub-item groups, or even just data sub-items, are placed between pairs of tags.

The tags appear as follows: <variable>, and </variable>, with variable being any word, or character string. Further, each data sub item group can be itself broken down into a number of sub-items. This structure is convenient and allows for easy manipulation and searching of the complete data item.

The XML document shown on page 1 of Appendix 1 shows a simple address book containing the details for two people: Tom Gardner, and Steve Battle. These names can be found between the <name> pairs of tags. The addresses for each of these individuals can be found between the tags <address>, but this address information is broken down into a number of data sub-items: <street>, <town>, and <postcode>. Similar groups can also be seen for <telephone> and <email> details. It should be noted that the XML document contains both personal and business details for the two individuals in the address book.

Page 2 of appendix I shows a possible XSLT document that can filter the XML address book to generate an HTML document that can be rendered by a PC browser, or other similar device. The XSLT document takes specified portions of the XML document, and generates the HTML code shown on page 4 of Appendix I. The XSLT document shown only takes work details for each individual from the XML document. When rendered the HTML document shown on page 4 appears as shown in the table at the bottom of page 4, appendix I. It should be noted the XSLT document has filtered the contents of the XML document so that only the business details of the two individuals have been allowed through.

Page 5, appendix I, shows a second XSLT document also suitable from filtering the XML document of appendix 1. However, rather than producing an HTML document, style sheet of page 5 generates a WML document suitable for display on WAP phones, and other similar handheld device with low display capabilities. In this example rather than pulling the business details from the XML document, the WML generation style sheet only outputs the personal contact details of the two individuals, thus preventing the business details from being passed.

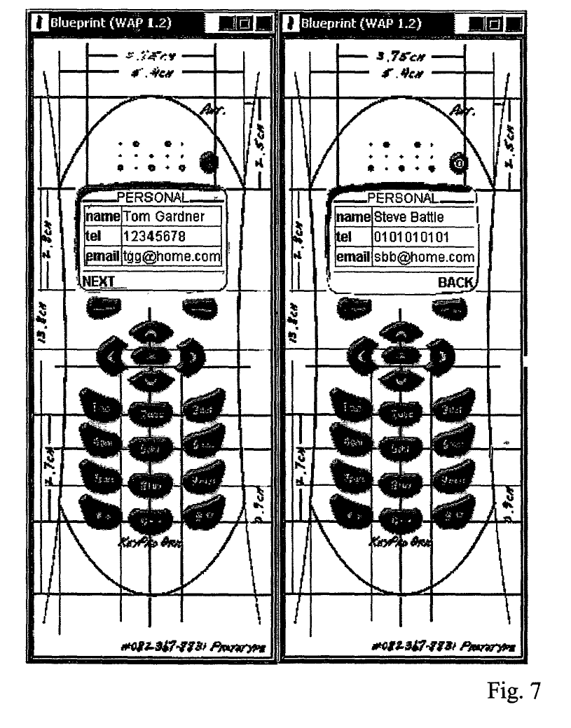

The WML generated by the XSLT document is shown on page 7 of appendix I, and a picture showing how the XML would appear on a WAP phone (In this example a NOKIA™) is seen in FIG. 7.

The skilled person will appreciate that within the meaning of this document a document written in a page description language needs to be rendered to be displayed on the display 2, whereas a document written in a content mark up language needs to be transformed and subsequently rendered.

[image]

[image]

[image]

[image]

[image]

[image]

[image]

[image]

We claim:

1. A method of developing a source document, said source document for display on a plurality of target devices and being written in at least one of a content markup language and a page description language, said method comprising concurrently performing at least one of transforming and rendering said source document into at least two outputs, with each of said outputs showing how said source document would be displayed on a predetermined target device and said method further comprising displaying said outputs for a user to view.

2. A method according to claim 1 wherein said source document is written in an XML (eXtensible Markup Language) specification language.

3. A method according to claim 1 wherein at least one transform module is provided, said transform module being arranged to transform data and being written in XSLT (eXtensible Stylesheet Language Transformations), said method comprising using said transform module to transform said source document into one of said outputs.

4. A method according to claim 3 wherein said transform module has an activated state in which said transform module transforms said source document into one of said outputs and a de-activated state in which said transform does not transform said source document into one of said outputs, and the method comprising causing said transform module to be in one of the activated and de-activated state as desired.

5. A method according to claim 1 wherein a render module is provided, said render module having an activated state in which it renders one of said outputs for display and a de-activated state in which it does not render one of said outputs and, the method comprising causing said render module to be in the activated state in order to display said outputs on a display.

6. A method according to claim 4 wherein said transform modules that are in said activated state are obtained from any the following sources: from a mass storage device, such as the hard drive of a computer and loaded into the memory of the computer for use; from a mass storage device of a computer and be made available for access by the computer when needed; from any other computer readable medium.

7. A method according to claim 6 wherein said transform modules that are in said activated state are downloaded from a remote source.

8. A method according to claim 7 wherein said transform modules that are in said activated state are downloaded from an Internet site.

9. A method according to claim 5 wherein said render modules that are in said activated state are obtained from any of the following sources: from a mass storage device, such as the hard drive of a computer and loaded into the memory of the computer for use; from a mass storage device of a computer and be made available for access by the computer when needed; from any other computer readable medium.

10. A method according to claim 9 wherein said transform modules that are in said activated state are downloaded from a remote source.

11. A method according to claim 10 wherein said transform modules that are in said activated state are downloaded from an Internet site.

12. A method according to claim 1 wherein a display is provided, said display being arranged to have at least two windows displayed thereon, and said method comprising displaying one of said outputs in one of said windows.

13. A method according to claim 1 wherein a display is provided and said display is arranged to display a text entry window in which said source document can be edited and said method comprising allowing a user to edit said source document.

14. A method according to claim 1 in which said source document is acquired from one of the following: a news feed; a similar source.

15. A method according to claim 1 wherein a display is provided and arranged to display a list of said target devices and a user input is provided, said user input being capable of receiving inputs from a user, and said method comprising allowing said user to specify using said user input on which of said target devices they wish said output to be displayed.

16. A method according to claim 15 comprising obtaining at least one of a transform module and a render module for each target device that a user specifies.

17. A system comprising a display, said display being arranged to allow concurrent display of at least two outputs generated from a source document, said source document for display on a plurality of target devices and being written in at least one of a content markup language and a page description language, each of said outputs being generated by at least one of an associated transform module and an associated render module from said source document, and each of said outputs showing how said source document would be displayed on a particular one of said target devices, said system further comprising at least one input, arranged to allow said source document to be edited, and processing circuitry arranged to perform at least one of transforming and rendering said source document into each of said at least two outputs.

18. A system according to claim 17 wherein said processing circuitry is arranged to cause said display to display simulations of at least one of the following: a WAP telephone; a television set; an Internet browser; any other Internet enabled device.

19. A system according to claim 17 wherein said display is arranged to display a list of said target devices and said input is arranged to allow a user to select from said list of said target devices said target devices for which they wish a simulation to be displayed.

20. A system according to claim 17 wherein said processing circuitry is arranged to generate said outputs from said transform module in substantially real time.

21. A system according to claim 17 arranged such that a user can periodically cause said system to generate said outputs.

22. A system according to claim 21 wherein said input is arranged to provide a user with an option to cause said outputs to be generated.

23. A system according to claim 17 comprising a data feed arranged to provide said source document.

24. A system according to claim 17 comprising data arranged to be used to generate said source document.

25. A system according to claim 17 arranged to generate said source document from data, said system comprising data that can be used to generate said source document.

26. A computer readable medium having stored therein instructions for causing a processing unit to execute the method of claim 1.

27. A machine comprising a display, said display being arranged to concurrently display a number of outputs generated by said method of claim 1.

28. A system comprising a display means for displaying information, said display being arranged to allow concurrent display of at least two outputs generated from a source document, said source document for display on a plurality of target device means for receiving and displaying data and being written in at least one of a content markup language and a page description language, each of said outputs being generated by at least one of an associated transform module means for transforming an input to an output and an associated render module means for rendering an input on a display from said source document, and each of said outputs showing how said source document would be displayed on a particular one of said target device means, said system further comprising at least one input means for receiving an input, arranged to allow said source document to be edited, and processing means for processing data arranged to perform at least one of transforming and rendering said source document into each of said at least two outputs.
